(19) United States
(12) Patent Application Publication
(10) Pub. No.: US 2005/0132839 A1
(43) Pub. Date: Jun. 23, 2005

(54) Retaining seat device of bicycle auxiliary handle for fixing bicycle auxiliary handle to general handle

(76) Inventor: Chun-Feng Chen, Taichung Hsien (TW)

Correspondence Address: Chun-Feng Chen, 235 Chung-Ho, Box 8-24, Taipei, TW

(21) Appl. No.: 10/795,866

(22) Filed: Mar. 9, 2004

(30) Foreign Application Priority Data
Dec. 18, 2003 (TW) 092222156

(51) Int. Cl. B62K 1/00

(52) U.S. Cl. 74/551.8

(57) ABSTRACT

A retaining seat device of a bicycle auxiliary handle for fixing a bicycle auxiliary handle to a general handle; the retaining seat device comprising: two cushions; a transversal tube having a retaining block at a front end thereof and a middle section; the retaining block serving for fixing the bicycle auxiliary handle to a front center of the general handle; two retaining seats. Each retaining seat has a groove corresponding to a shape of a periphery of the middle section of the transversal tube. A lower outer side of each retaining seat having a positioning hole for receiving a respective distal tube; a top side of each retaining seat has a plurality of adjusting holes for fixing a corresponding one of the two cushions and adjusting a distance between the two cushions. Furthermore, a positioning seat can be installed above a retaining seat for receiving the two distal tubes.

### FIELD OF THE INVENTION

The present invention relates to bicycle handle, and more particular to a retaining seat device of a bicycle auxiliary handle for fixing a bicycle auxiliary handle to a general handle. The retaining seat will cause the bicycle auxiliary handle to be steadily and safely installed to a bicycle without vibration.

### BACKGROUND OF THE INVENTION

In the prior art, the bicycle handle is made of a round tube with two ends of the tube being bent to be as two holding portions. To have a preferred holding feeling, as shown in FIG. 1, a prior art bicycle handle is illustrated. The ox horn shape bicycle handle 2 has two ends. Each end has a first holding portion 21 which is a round tube. The two first holding portions 21 are connected with respective elliptical cross section portions 22. The two elliptical cross section portions 22 are connected through a middle section 20. A middle section 23 of the handle is used to combine with a transversal tube of a stand tube. Since the prior art handle has a shape like a horn, thereby, this kind of handle is called as a horn shape bicycle handle.

Further, referring to FIG. 2, it is illustrated that an auxiliary handle 4 is added to the prior art handle 3. The auxiliary handle 4 is formed by two L shape tubes. The middle sections thereof are parallel. One end of each L shape tube is formed with a handle 41. The handles 41 face forward so that the user can hold the handles. A tube 41 is connected to a respective holding portions 411. Another end of the L shape tube has a cushion 42. A lower side of each tube 41 is downwards extended with a retaining seat 43. A round handle 3 is connected between the two retaining seats 43 by the two ends of the round handle 3 being inserted into the two retaining seats 43. Thereby, the auxiliary handle 4 is locked to the round handle 3. In driving, the two hands of the user hold the holding portions 411 and the elbows of the user rest upon the two cushions. However, this will cause the retaining seats rotate along the round handle 3. For a long time, the combination of the handle 3 and 4 will become loose so as to effect the user. This make the user feel uneasy, even some accidents occur. Moreover the horn shape bicycle handle 2 is an elliptical cross section so that it cannot match the size of the round tube. Even, different kinds of horn shape handles have different elliptical cross sections. Thus, other type of handle must be formed for matching the size of the horn shape handle.

### SUMMARY OF THE INVENTION

Accordingly, the primary object of the present invention is to provide a retaining seat device of a bicycle auxiliary handle for fixing a bicycle auxiliary handle to a general handle, wherein the retaining seat will cause the bicycle auxiliary handle to be steadily and safely installed to a bicycle without vibration.

To achieve above object, the present invention provides a retaining seat device of a bicycle auxiliary handle for fixing a bicycle auxiliary handle to a general handle; the retaining seat device comprising: two cushions; a transversal tube having a retaining block at a front end thereof and a middle section; the retaining block serving for fixing the bicycle auxiliary handle to a front center of the general handle; two retaining seats. Each retaining seat has a groove corresponding to a shape of a periphery of the middle section of the transversal tube. A lower outer side of each retaining seat having a positioning hole for receiving a respective distal tube; a top side of each retaining seat has a plurality of adjusting holes for fixing a corresponding one of the two cushions and adjusting a distance between the two cushions.

### BRIEF DESCRIPTION OF THE DRAWINGS

FIG. 1 is a schematic view about the prior art horn shape bicycle handle.

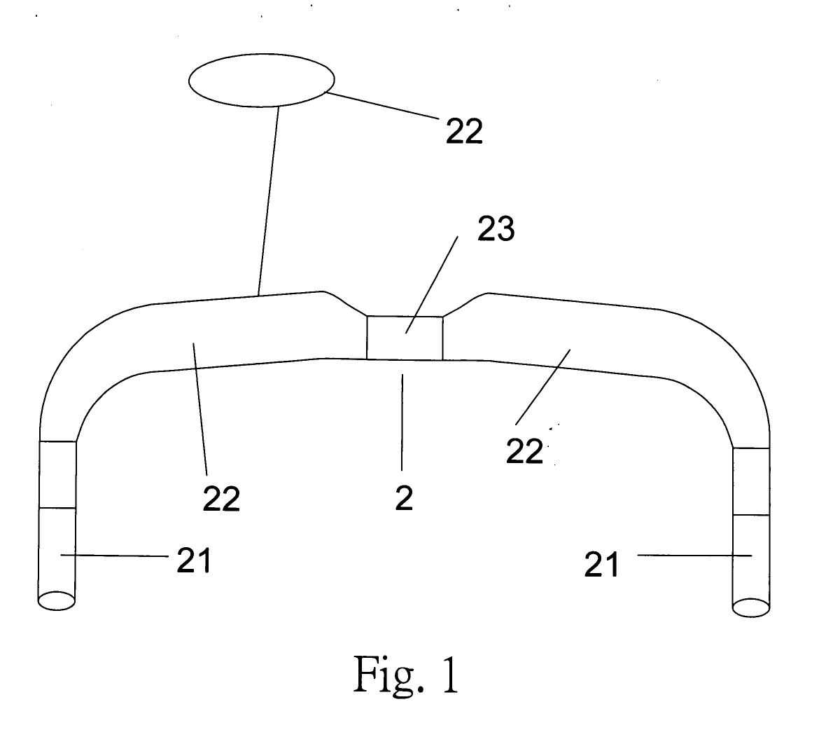

FIG. 2 is a schematic perspective view showing that an auxiliary handle is installed to a prior art bicycle handle.

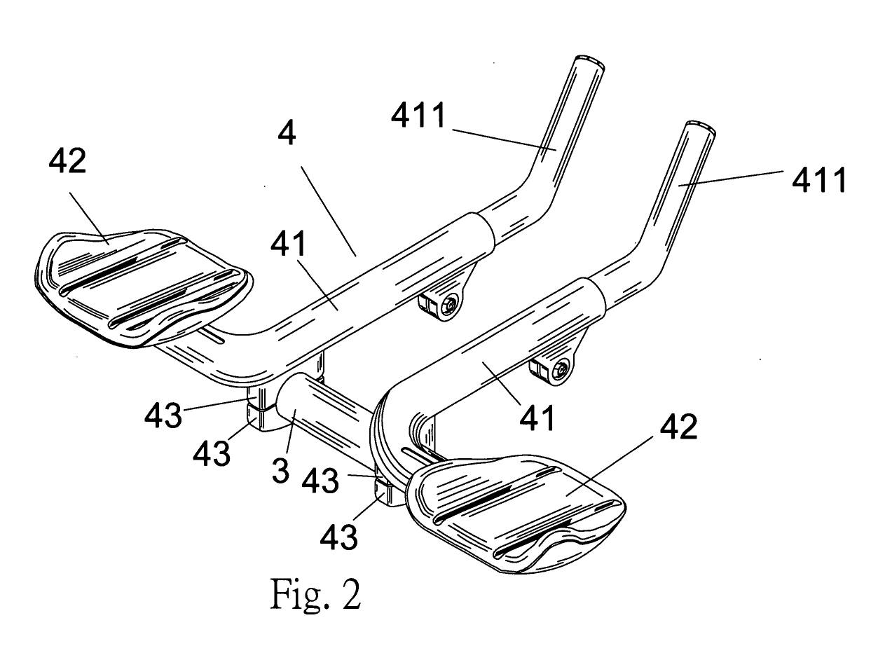

FIG. 3 is an exploded perspective view of the present invention.

FIG. 4 is an assembled schematic view of the present invention.

FIG. 5 is a schematic view showing the structure of the present invention.

FIG. 6 is an exploded perspective view of the second embodiment of the present invention.

FIG. 7 is an assembled schematic view of the second embodiment of the present invention.

FIG. 8 is a schematic view showing the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

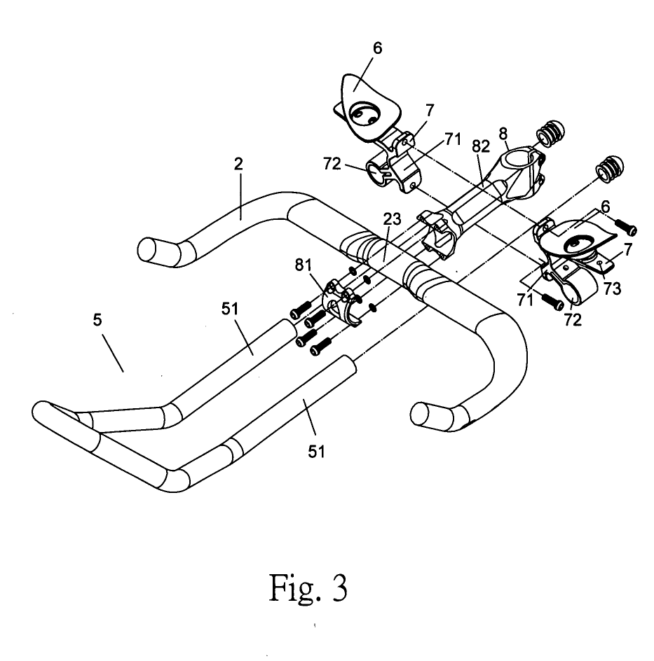

Referring to FIGS. 3, 4 and 5, the retaining seat device of a bicycle auxiliary handle of the present invention is illustrated. The retaining seat device serves to fix the bicycle auxiliary handle to a general used handle 2 (in this example, a horn shape handle is used as an example).

The device is formed by an auxiliary handle 5 having two parallel distal tubes 51; two cushions 6 and two retaining seats 7 for fixing the auxiliary handle 5. A transversal tube 8 has a retaining block 81 at a front end thereof for fixing the auxiliary handle 5 to a front center of the general handle 2 and a middle section 82. A periphery of the middle section 82 has a round shape. Each retaining seat 7 has a groove 71 corresponding to a shape of a periphery of the middle section 82 of the transversal tube 8. In assembly, the two grooves 71 of the two retaining seats 7 are oppositely arranged so as to be combined as a hole for receiving the middle section 82. A lower outer side of each retaining seat 7 has a positioning hole 72 for receiving a respective distal tube 51. A topside of each retaining seat 7 has a plurality of adjusting holes 73 for fixing a corresponding one of the two cushions 6 and adjusting a distance between the two cushions 6.

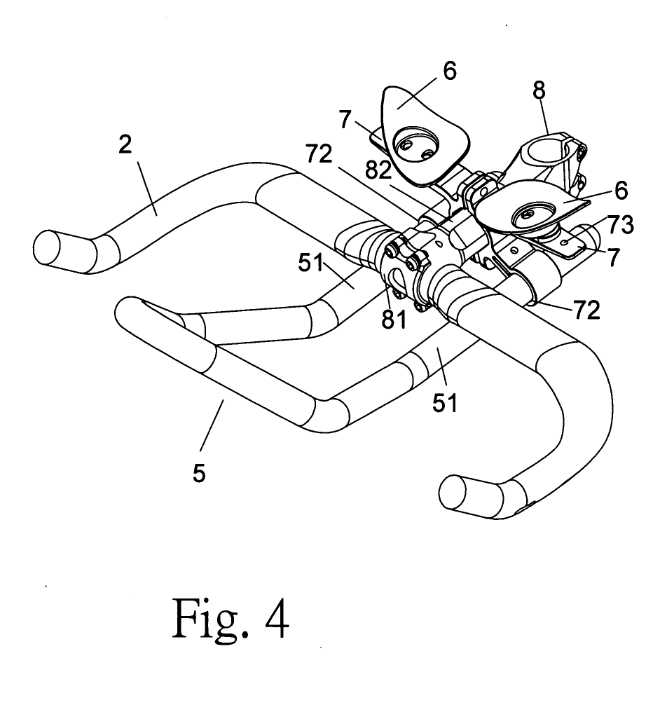

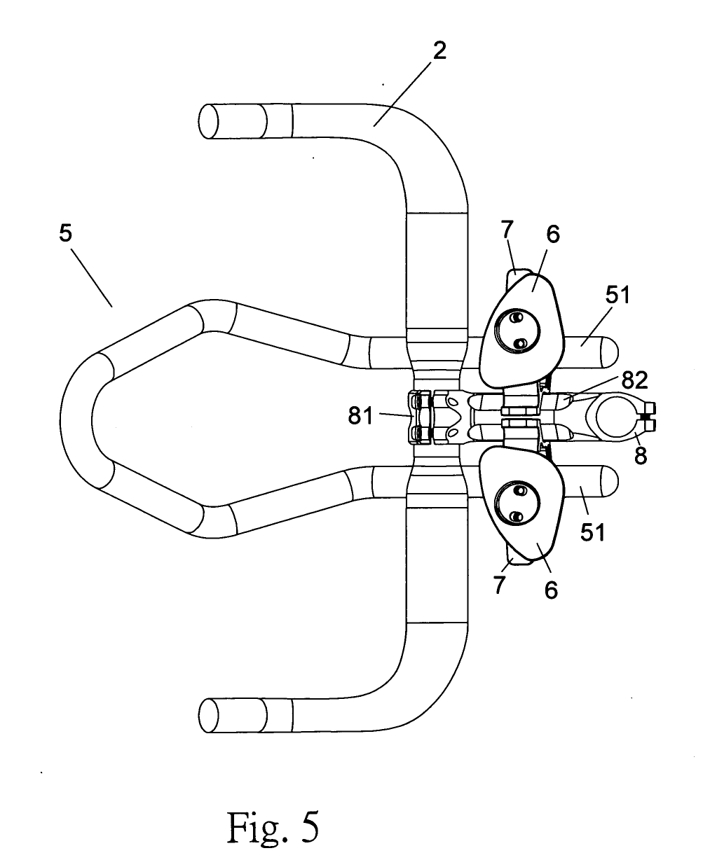

Further referring to FIGS. 4 and 5, it is illustrated that the two retaining seats 7 are fixed to a middle portion of a transversal tube of a general handle 2 instead of being fixed at two ends of a general handle 2. Furthermore, the auxiliary handle 5 of the present invention can be used in various handle without confining by the shape of the general handle 2.

In the assembly view, the two retaining seats 7 are assembled to the middle section 82 of the transversal tube 8. A front center 23 of the handle 2 serves to fix the transversal tube 8. When the elbows of the user place against the two cushions 6. The auxiliary handle 5 is difficult to rotate with respect to the periphery of the middle section 82 of the transversal tube 8.

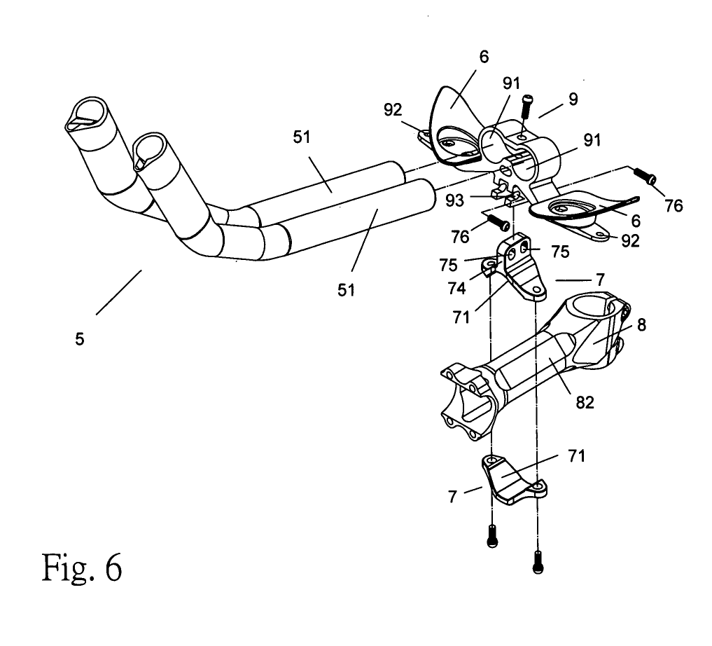

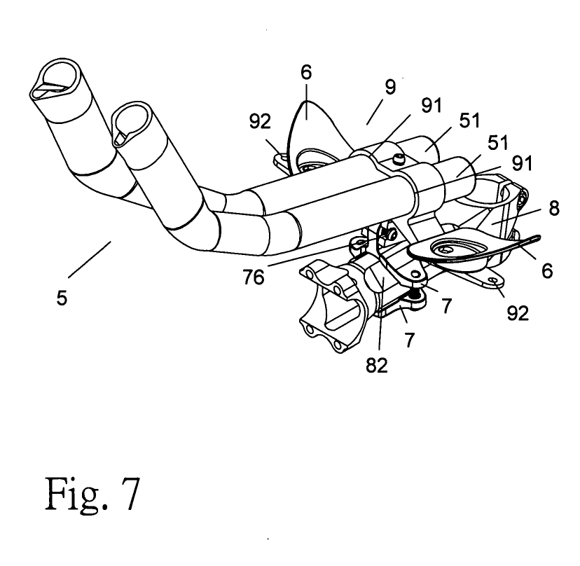

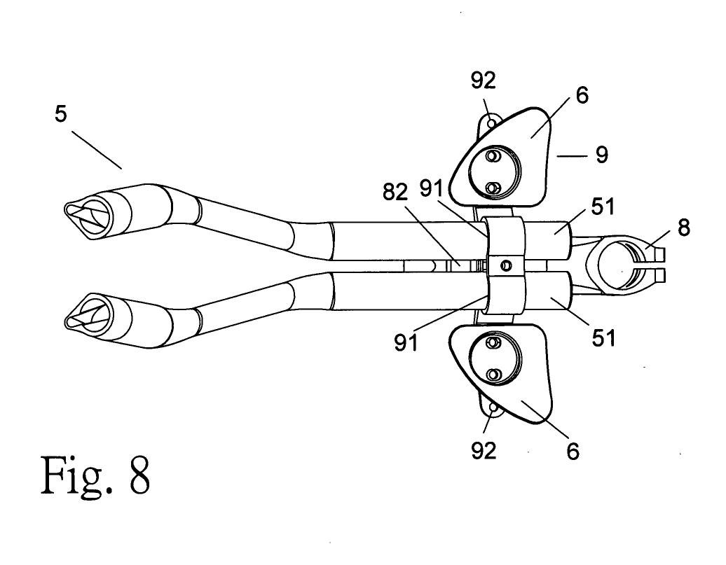

Referring to FIGS. 6, 7, and 8, the second embodiment of the present invention is illustrated. The retaining seat device of a bicycle auxiliary handle is formed by an auxiliary handle 5 having two parallel distal tubes 51; two cushions 6 and one retaining seat 7 for fixing the auxiliary handle 5. A transversal tube 8 has a retaining block 81 at a front end thereof for fixing the auxiliary handle 5 to a front center of the general handle 2 and a middle section 82. A periphery of the middle section 82 has a round shape.

The retaining seat 7 has two locking pieces 71 at a lower side thereof. The two locking pieces 71 serve to lock the retaining seat 7 to the transversal tube 8 by locking two locking pieces 71 using studs.

A positioning seat 9 is located above the retaining seat 7. The positioning seat 9 has two adjacent positioning holes 91 at a top center of the positioning seat 9. Each for receiving a distal tube 51. Each of two opposite middle outer sides of the positioning seat 9 has a plurality of adjustable holes 73. A lower center of the positioning seat 9 has at least one combining hole 93. At least one stud 76 passes through the connecting hole 75 of the protrusion 74 and the combining hole 93 of the positioning seat 9 for combining the retaining seat 7 and the positioning seat 9.

In assembly, the auxiliary handle 5 is combined to the middle section 82 of the transversal tube 8.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A retaining seat device of a bicycle auxiliary handle for fixing a bicycle auxiliary handle to a general handle; the retaining seat device comprising:
two cushions;
a transversal tube having a retaining block at a front end thereof and a middle section; the retaining block serving for fixing the bicycle auxiliary handle to a front center of the general handle;
two retaining seats; each retaining seat having a groove corresponding to a shape of a periphery of the middle section of the transversal tube; in assembly, the two grooves of the two retaining seats being oppositely arranged so as to be combined as a hole for receiving the middle section; a lower outer side of each retaining seat having a positioning hole for receiving a respective distal tube; a top side of each retaining seat has a plurality of adjusting holes for fixing a corresponding one of the two cushions and adjusting a distance between the two cushions.

2. A retaining seat device of a bicycle auxiliary handle for fixing a bicycle auxiliary handle to a general handle; the retaining seat device comprising:
two cushions;
a transversal tube having a retaining block at a front end thereof and a middle section; the retaining block serving for fixing the auxiliary handle to a front center of the general handle;
a retaining seat having two locking pieces at a lower side thereof; the two locking pieces serving to lock the retaining seat to the transversal tube by locking two locking pieces;
a positioning seat being located above the retaining seat; the positioning seat having two adjacent positioning holes at a top center of the positioning seat; each for receiving a distal tube; each of two opposite middle outer sides of the positioning seat having a plurality of adjustable holes; a lower center of the positioning seat having at least one combining hole; at least one stud passing through the connecting hole of the protrusion and the combining hole of the positioning seat for combining the retaining seat and the positioning seat;
wherein in assembly, the auxiliary handle is combined to the middle section of the transversal tube so as to further combine with general handles of various shapes.
